(19) United States
(12) Patent Application Publication
(10) Pub. No.: US 2004/0102937 A1
(43) Pub. Date: May 27, 2004

(54) Energy forecasting using model parameter estimation

(75) Inventor: Mohamed M. Ibrahim, Bangalore (IN)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/302,599

(22) Filed: Nov. 21, 2002

(51) Int. Cl. G06F 17/10

(52) U.S. Cl. 703/2

(57) ABSTRACT

A seasonal autoregressive moving average (SARIMA) model that represents seasonal variation and a linear regression method to reflect peak load variation due to temperature are used to forecast energy needs. In one embodiment, a Kalman filter is used for model parameter estimation. The use of the Kalman filter provides optimal parameter estimation even under noisy data conditions. It also handles iterative computations of the SARIMA model efficiently. The method provides a forecast every fifteen minutes in one embodiment for several buildings. A user specifies a building ID, number of history data and the date for which the forecast is to be done. A model underlying the data is identified, parameters are estimated for the model, and a forecast is provided for future consumption.

### FIELD OF THE INVENTION

The present invention relates to energy forecasting, and in particular to energy forecasting using model parameter estimation.

### BACKGROUND OF THE INVENTION

Efficient energy planning and management plays a vital role in cost-effective operation of commercial buildings. Energy consumption can range from a few watts in residences, to several megawatts in the industrial sector. Business establishments, such as restaurants, grocery stores, and retail stores rely on operation of many different types of equipment that require electricity. Energy use in commercial buildings is attributed to many factors, such as weather conditions, building schedule, and occupancy of the building to name a few. However, one of the most dynamic factors deciding peak energy consumption in a day is the weather. Temperature and humidity fluctuations are but a few of the weather related factors that contribute to determining peak energy consumption or load profile. At the same time, load profiles undergo seasonal, daily and weekly variation.

Lighting and HVAC (Heating Venting and Air Conditioning) together consume more than 50% of the total energy in typical commercial buildings. Since the operation schedule of HVAC is based on factors like physical parameters (air temperature, humidity etc.) and human perceptions (warm, cold etc.), there is a need to collect the same at regular intervals. This periodic task necessitates proper planning and maintenance to achieve energy efficient and hence cost-effective operation of equipment.

A recent study shows that ten to twenty-five percent of the energy currently used in commercial buildings for lighting, equipment and climate control could be saved with no adverse impacts on occupant comfort and without replacing existing building energy systems if the above periodic task is done properly. For example, in public and commercial buildings, it is possible to achieve a low electricity base load; the load that remains when the building is not in use. Yet in reality, base loads are often unnecessarily high, due to exhaust fans, air-handling equipment, air compressors, pumps and lighting left on during nights and weekends. Since most buildings are in use approximately only 30-50% of the time, reducing electricity consumption in the unoccupied hours to a practical minimum is a very effective way to conserve energy, at little or no cost. In fact, this step should precede all other energy conservation measures. Simple hourly registration of electricity consumption and storage of this data can make the base load explicit and give an indication of the saving potential. With analysis of operating regimes and/or additional measurements, the causes of inefficiencies can be tracked. By properly tuning the control mechanisms, the problem can be solved.

Performing such data analysis for efficient energy operation may be feasible for one or two buildings using regular staff. However when it comes to energy management in several buildings of the similar type or different type, it creates a host of problems. Hence an algorithm, tool or a framework that deals with the huge data storage and analysis in computer is required to assist the building operator to operate equipment in a cost effective manner.

Energy (or load) forecasting is one of the traditional methods being used by many of Energy Management System (EMS) to control and plan power system operation. The schedule of energy consuming equipment needs load forecast for the next few days with significant reliability so as to minimize their operating costs. Since the corrective or preventive actions on power system wholly dependent on this forecast information, the energy forecasts method is expected to be more reliable with considerable accuracy. An over forecast may result in unnecessary start up of some power units while too low a forecast may lead to inconvenience and inefficiency of the occupants. These facts necessitate efficient energy forecasting algorithm with ease of implementation and lower forecast error. Based on the lead-time, up to which the forecast is needed, energy forecasting is classified as short-term forecasting (few hours to a few weeks ahead), Medium term forecasting (few months to 5 years ahead) or long term forecasting (5 to 20 years ahead).

Several short-term load forecasting procedure have been used, from simple regression based techniques, exponential smoothing, state space methods to complex Neural Network based techniques. One of the most commonly used procedures for energy forecasting is time series analysis.

Among these techniques, regression analysis is one of the oldest approaches for load forecasting problem. In such analysis, the total load is divided into a standard load component and a component linearly dependent on some explanatory variables like weather factors. Insensitivity to occasional disturbances in the measurements and easy implementation are the two major advantages of regression based load forecasting. However, regression analysis needs building operator's intervention for the segregation of load into different components. Also serial correlation while applying regression on time series may cause problem.

Another commonly used load forecasting technique is heuristic models based expert systems. Such systems basically try to imitate the reasoning of a human operator. For example, like a human operator, it searches in the database for a day that corresponds to the target day with regard to the day of the week, social factors and weather factors. Then the load values of similar days are taken as basis for the forecast. An expert system is thereby an automated version of this search process and is attractive for a system operator providing the user with the line of reasoning followed by the model. Like regression analysis, expert system based solutions require operator intervention in framing heuristic rules for database search. Also the fact that the ignorance of trend in load if any make it unsuitable in scenarios where the net energy consumption grows with time.

Many of the modem day energy management systems (EMS) rely on Artificial Neural Networks (ANN) technique for many of their power system application research including short-term load forecasting. A Multi-Layer Perceptron (MLP) network is widely used for such application owing to its ability to learn the complex relationship between input and output patterns. The network is trained with actual load data from the past. The inputs to the network are generally the present and past load values and outputs are future load values. Unlike other methods, ANN can represent nonlinear relationships between load and temperature making the forecast results more accurate. However its implementation for energy modeling and forecasting is very complex. Especially the problem of convergence while training the network with huge energy database can be observed many times.

A stochastic time series model is a classic dynamic forecasting method with a variety of parametric models from a simple AutoRegressive (AR) model to complex Seasonal Vector AutoRegressive Integrated Moving Average model (SARIMAX). Among two different approaches, the self projecting approach (AR, MA, ARMA, VARMA, SARIMA etc) models the load data in terms of its past values taking into consideration the seasonality, random disturbances, etc. A cause and effect approach (Transfer Function model) incorporates explanatory variables like weather factors, thereby making the time series method more dynamic. Its edge over other methods is in terms of its relatively easy and quick model identification and estimation procedure. It's also possible to compute confidence interval for the forecast from the variance computation of white noise making it more reliable.

### SUMMARY OF THE INVENTION

A seasonal autoregressive moving average (SARIMA) model that represents seasonal variation and a linear regression method to reflect peak load variation due to temperature are used to forecast energy needs. In one embodiment, a Kalman filter is used for model parameter estimation. The use of the Kalman filter provides optimal parameter estimation even under noisy data conditions. It also handles iterative computations of the SARIMA model efficiently.

The method provides a forecast every fifteen minutes in one embodiment for several buildings. A user specifies a building ID, number of history data and the date for which the forecast is to be done. A model underlying the data is identified, parameters are estimated for the seasonal model, and a forecast is provided for future consumption.

In one embodiment, the SARIMA model is modified to reflect temperature effect on peak consumption by utilizing a shift derived from cross correlation analysis relating consumption and temperature.

### BRIEF DESCRIPTION OF THE DRAWINGS

FIG. 1 is a graph showing characteristics of load curve for a typical commercial building.

FIG. 2 is a graph showing weekly seasonality of energy consumption for the typical commercial building of FIG. 1.

FIG. 3 is a graph showing an autocorrelation function (ACF) without differencing.

FIG. 4 is a graph showing an ACF after non-seasonal differencing.

FIG. 5 is a graph showing an ACF after seasonal and non-seasonal differencing.

FIG. 6 is an ACF plot of a seasonal autoregressive moving average (SARIMA) model results.

FIG. 7 is a autocorrelation function (PACF) plot of the SARIMA model results.

FIG. 8 is a convergence curve of a maximum likelihood estimation (MLE) for estimating model parameters.

FIG. 9 is plot of an ACF of residuals used to check the model.

FIG. 10 is a flowchart of data differencing, model order identification, parameter estimation and model diagnostic checking in accordance with the present invention.

FIG. 11 is a graph of forecasting results of one SARIMA model.

FIG. 12 is a graph showing peak load versus peak temperature for a typical commercial building.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

The functions or algorithms described herein are implemented in software in one embodiment, where the software comprises computer executable instructions stored on computer readable media such as memory or other type of storage devices. The term “computer readable media” is also used to represent carrier waves on which the software is transmitted. Further, such functions correspond to modules, which are software, hardware, firmware of any combination thereof. Multiple functions are performed in one or more modules as desired, and the embodiments described are merely examples. The software is executed on a digital signal processor, ASIC, microprocessor, or other type of processor operating on a computer system, such as a personal computer, server or other computer system.

Characteristics of a load curve for a typical commercial building are first described. This is followed by a section describing modeling of energy data, including model identification, model estimation and model diagnostic checking. Using the models to forecast energy consumption is then described followed by description of a Kalman filter to modify parameters associated with the model to enhance accuracy. The Kalman filter is a set of mathematical equations that provides an efficient computational (recursive) solution of the least-squares method. The filter is very powerful in several aspects: it supports estimations of past, present, and even future states, and it can do so even when the precise nature of the modeled system is unknown.

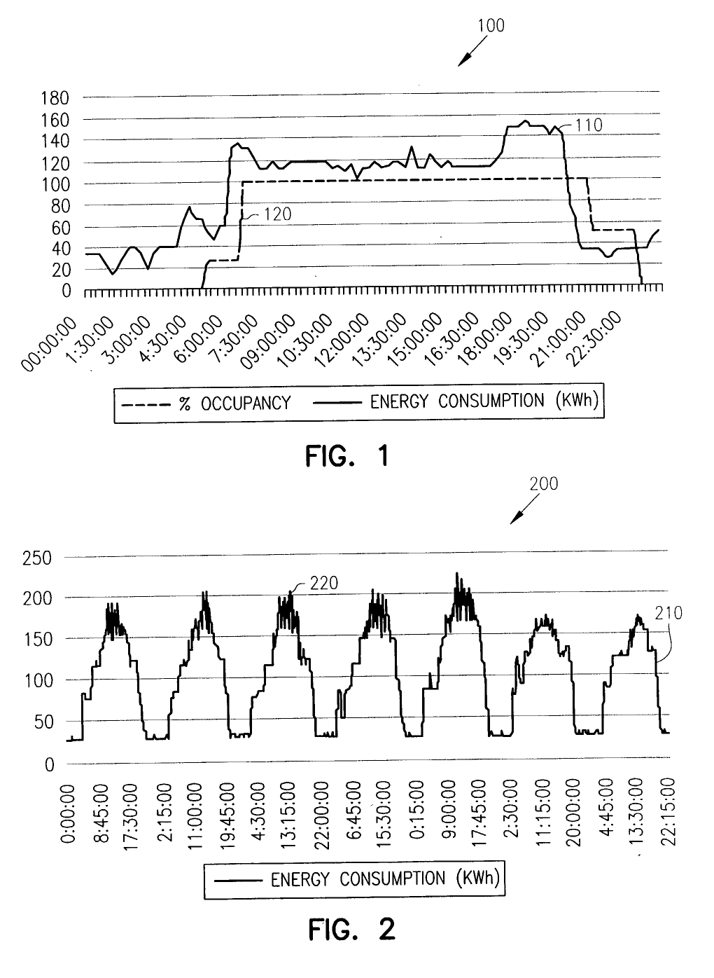

A load curve in a typical commercial building on a particular day is shown at 100 in FIG. 1. Both a rate of power or energy consumption 110 and a percentage of occupancy 120 for the building are shown. The load curve can be divided into three major regions. One region corresponds to when the building is operated with minimum base load during non business hours. A second region corresponds to peak load during business hours and a third region corresponds to a transition region between the first and second regions. The extent of these regions depends on the building schedule and/or the occupancy status of the building.

The operating load oscillates around some base load (approx. 40 KWh in this example) till about 4:30 hrs when the building is unoccupied. Similarly during the peak business hours of between 9:00 hrs to 19:00 hrs, the energy consumption is at its peak (approx. 120 KWh) when the building is 100% occupied. Also seen in FIG. 1 are two sudden jumps in the energy consumption at start and end of business hour during which the occupancy level gradually rise (from 0% to 100%) and fall (from 100% to 0%) respectively. The fluctuations around some constant energy level seen in each of these three regions are due to the occasional usage of certain equipment like lift, heaters, elevators etc.

The basic load pattern discussed above remains the same throughout the year for a particular building. For example the energy consumption for one week's time from Monday through Sunday is shown at 200 in FIG. 2 where the day to day variation of load 210 follows the same pattern. The only difference is in the peak energy consumption 220. As seen in the FIG. 2, the peak load keeps growing as the week progresses and during the weekends, it is relatively less than weekdays. Thus, it is inferred that the peak load consumption depends on day of the week or in other words the peak load undergoes weekly seasonality.

Energy consumption undergoes daily and weekly seasonality (i.e.) the energy consumption at 11:00 a.m. on Wednesday can be related to consumption at 11:00 a.m. on Tuesday (daily seasonality) and consumption at 11:00 a.m. on the same day of the previous week.

Given the above facts, a mathematical model is built for the energy data using time series analysis. The most fundamental time series models are the autoregressive model and the moving average model. In autoregressive model AR (p), the current value of the process is expressed as a linear combination of ‘p’ previous values of the process and a random shock (or spike).

yₜ=φ₁*yₜ₋₁+ . . . +φₚ*yₜ₋ₚ+aₜ or

φ(B)yₜ=aₜ (1)

where yₜ and aₜ are energy consumption and random shock at time instant ‘t’ respectively. In the above expression, B denotes the delay operator.

(ie.) Byₜ=yₜ₋₁ and φ(B)=1−φ₁B−φ₂B²− . . . −φₚB^{p}

In the moving average model MA (q) the current value of the process is expressed as a linear combination of q previous random shocks.

yₜ=aₜ−θ₁*aₜ₋₁− . . . −θₚ*a_{t-q} or

yₜ=θ(B) aₜ (2)

The mixed autoregressive moving average model ARMA (p,q) expresses the current value of the process as a linear combination of ‘p’ previous values of the process and ‘q’ previous shocks.

yₜ=φ₁*yₜ₋₁+ . . . +φₚ*yₜ₋ₚ+aₜ−θₜ*aₜ₋₁− . . . −θₚa_{t-q} or

φ(B)yₜ=θ(B)aₜ (3)

To apply the daily seasonality of energy consumption (i.e.) load at say 10 A.M. on Thursday is related to load at 10 A.M on Wednesday, there is a need to include a seasonal ARMA (P,Q) model

φ(B^{P})yₜ=θ(B^{Q})aₜ (4)

to the general ARMA (p,q) model.

Similarly to reflect the weekly periodic variation (i.e.) load at 10 A.M. on Thursday is related to load at 10 A.M on the same day of the previous week, another seasonal ARMA (P′,Q′) model

φ(B^{P′})yₜ=θ(B^{Q′})aₜ (5)

may be needed to include in the tentative complete model.

These seasonal (ARMA (P,Q) & ARMA (P′,Q′)) and non-seasonal models (ARMA (p,q)) can be combined either as an additive model or multiplicative model. Such combined integrated model is called as Seasonal AutoRegressive Moving Average (SARMA) model. For example the multiplicative SARMA (p,q)* (P,Q) model considering daily seasonality can be written as

φₚ(B)φₚ(B^{P})yₜ=θ_{q}(B)θ_{Q}(B^{Q})aₜ (6)

The main criteria to apply these time series models is that the data should exhibit stationarity in mean and variance (i.e.)

(i) mean and variance shouldn't be a function of time and

(ii) the autocorrelation should be a function of time difference

However most of the real time data in general are of a non-stationary in nature. For example the average energy consumption in a commercial building doesn't remain the same, but keeps changing. This variation may be due to seasonal change (the power consumption in summer may not be the same as in winter) or due to the inclusion of new equipment in the building.

Hence before applying Seasonal AutoRegressive Moving Average (SARMA) Models to the energy data, it needs to be converted to stationary data. This could be achieved by differencing of the data series with respect to its past sample(s). SARMA model then would be called as Seasonal AutoRegressive Integrated Moving Average SARIMA (p,d,q)* (P,D,Q) model where d and D denotes non-seasonal and seasonal order of data differencing. For example a first order (d=1) non-seasonal data diffrencing can be expressed as

y(t−1)=y(t)−y(t−1)t=2,3, . . . , N (7)

where N is the number of history data. Similarly the first order (D=1) seasonal diffrencing with period ‘s’ can be expressed as

y(t−s)=y(t)−y(t−s)t=s+1,s+2, . . . , N (8)

The complete SARIMA model is therefore can be written as

φₚ(B)φ_{P}(B^{s})∇^{d}∇ₛ^{D}yₜ=θ_{q}(B)θ_{Q}(B^{s})aₜ (9)

where φₚ(B) & φ_{P}(B^{s}) are AR terms of non-seasonal model with order ‘p’ and seasonal model with order ‘P’ respectively and θ_{q}(B) & θ_{Q}(B^{s}) MA terms of non-seasonal model with order ‘q’ and seasonal model with order ‘Q’ respectively.

The modeling of energy data using SARIMA model can be seen as three step procedure:

(i) The model Identification: The order of data diffrencing (d & D) and AR, MA model orders (p,q,P,Q) will be decided in this phase.

(ii) Model Estimation: The model parameter (φ& θ) are estimated using Maximum Likelihood Estimation (MLE) method

(iii) Model diagnostic checking: The adequacy of the model would be checked in this phase of modeling.

Model Identification:

The Autocorrelation Function (ACF) and Partial Autocorrelation Function (PACF) are the two major tools used for model identification. The autocorrelation can be defined as a measure of linear dependency between two random variables in the same time series. Suppose if autocovariance γₖ of random variable x with mean μ is expressed as

γₖ=E[(xₛ−μₛ)(xₜ−μₜ) for all s and t

then autocorrelation function can be written as

ρₖ=γₖ/γ₀ for all time lags k.

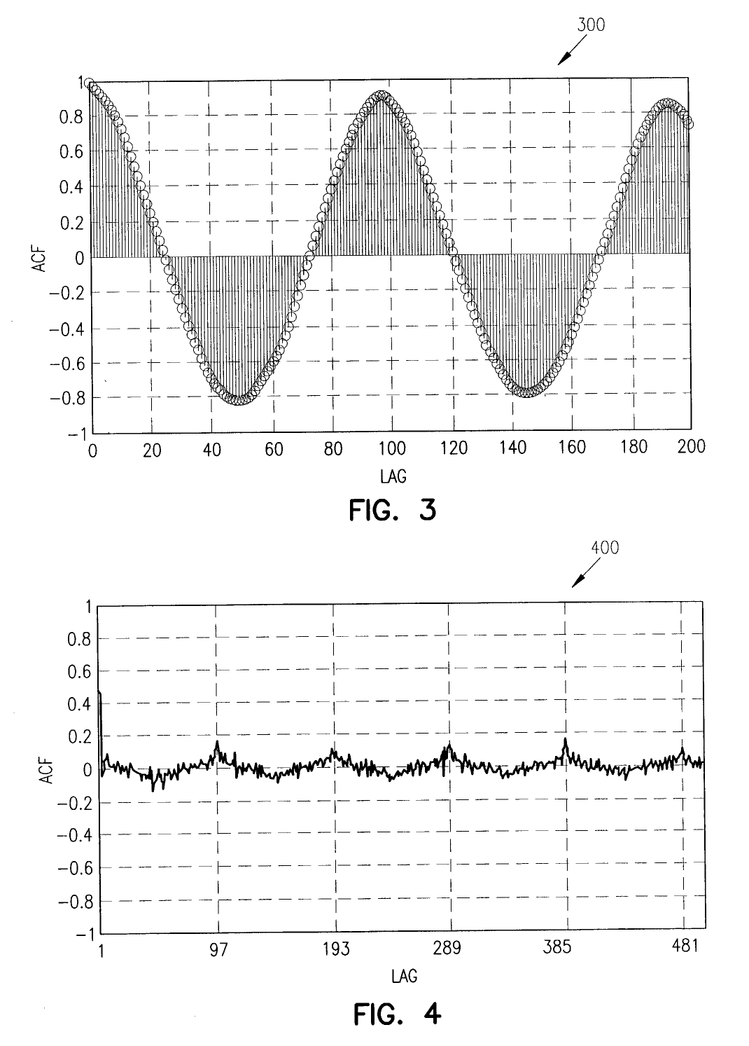

As stated earlier, the first step towards modeling is to check the stationary condition of data. If the ACF plot as seen at 300 in FIG. 3 decays exponentially instead of dying out immediately after few nonzero lags, then it is an indication of non-stationarity in the data. In case the data varies periodically then the decay of ACF plot too follows the similar periodicity. For example the ACF plot for the energy data of a building decaying exponentially indicates the need for data differencing to make it stationary.

Non-seasonal (or regular) first order data differencing is then performed. The corresponding ACF plot is shown at 400 in FIG. 4. Though the ACF plot decays very fast after few initial lags, it shoots up at lags 96, 192, 288 etc (multiples of 96) as pointed by arrows. It is evident that along with first order (d=1) non-seasonal differencing, seasonal differencing should also be performed.

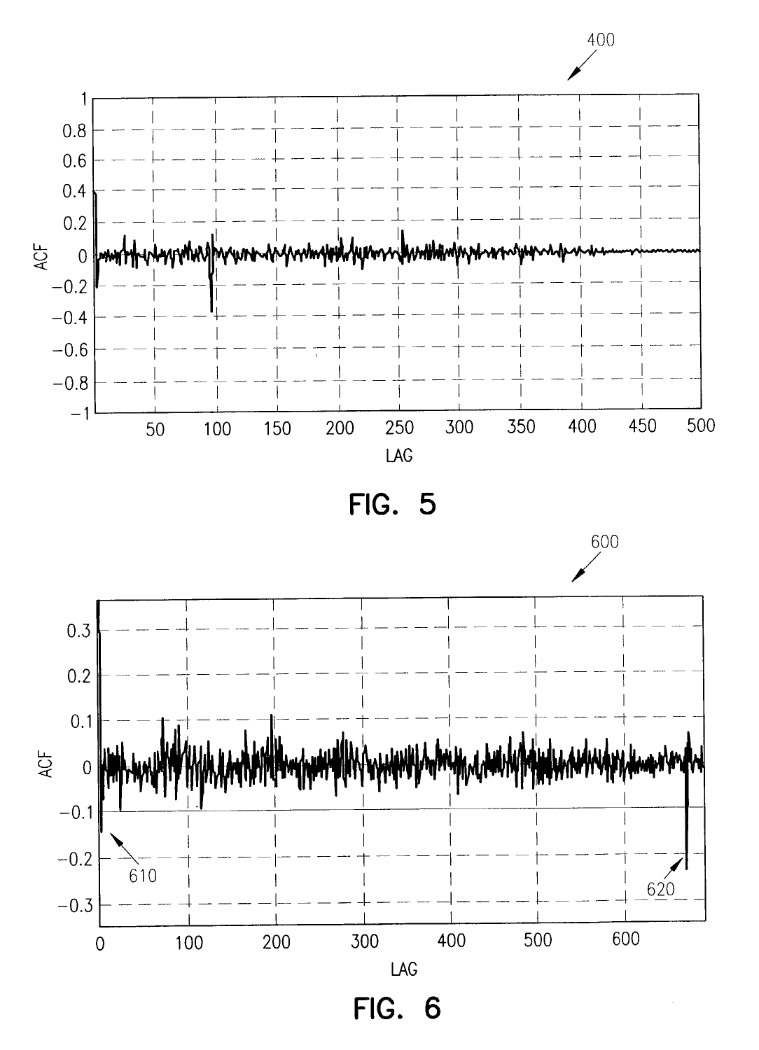

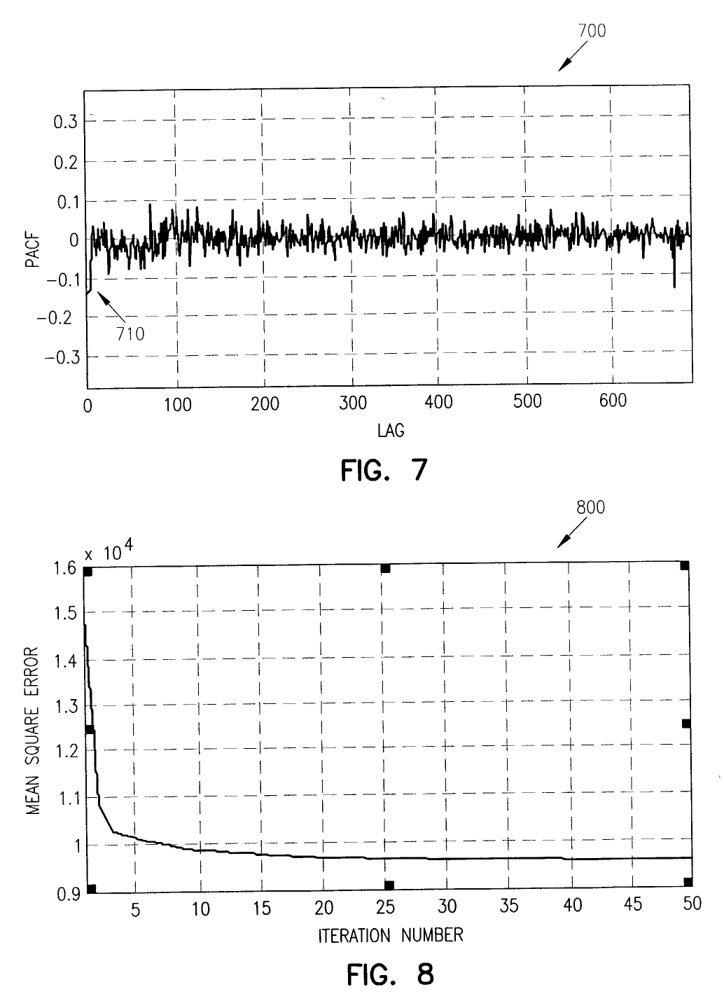

The ACF plot after such differencing is given at 500 in FIG. 5. Having made the data a stationary one, the next task is to identify the SARIMA model orders (i.e.) values of p,q,P and Q. ACF and PACF tools are used for this purpose too. Some of the facts in this model order identification procedures are

While ACF plot helps to find the order of a MA(q) model, PACF plot indicates the order of a AR(p) model.

In general, for a AR(p) process, ACF tails off to 0 immediately after the lag 0 and PACF plot cuts off to 0 after p lags.

In case of a MA(q) process, ACF plot cuts off to 0 after q number of lags and PACF tails off to 0 immediately after lag 0.

When the process follows ARMA(p,q) model, ACF plot tails off to 0 after q lags and PACF tails off to 0 after p lags.

For a SARIMA process, in addition to p nonzero values in PACF and q nonzero values in ACF plots near lag 0, there are P number of spikes in PACF plot at lags which are multiples of period s and Q number of spikes in ACF plot at those lags.

For example the ACF and PACF plots computed after regular and seasonal diffrencing for the energy data taken at 15 minutes interval in a commercial building are presented at 600 and 700 in FIG. s 6 and 7.

While the presence of a nonzero value 610 (values beyond the threshold bars in the figure) of ACF 600 near lag 0 indicates the presence of regular (or non seasonal) MA model of order 1, a nonzero spike 620 at lag 672 (15 min*24 hrs*7 days) indicates the presence of seasonal MA(1) model.

While the presence of a nonzero value 710 (values beyond the threshold bars in the figure) of PACF 700 near lag 0 indicates the presence of regular (or non seasonal) AR model of order 1, a nonzero spike 720 at lag 672 indicates that the presence of seasonal AR(1) model.

Combining the above two observations from ACF and PACF plots, it can be concluded that energy consumption in this reference building follows a SARIMA(1,1,1)*(1,1,1) model. Mathematically this can be expressed as

(1−φB)(1−φ′B⁶⁷²)∇¹∇₆₇₂¹yₜ=(1−θB)(1−θ′B⁶⁷²)aₜ (10)

It can be noted that the model orders are p=qP=Q=d=D=1 and data undergoes weekly seasonality (s=672).

Model Estimation:

The next task in the model building is to estimate the parameters (φ,φ′,θ and θ′) of the initial model identified in the previous section. The familiar method in the estimation theory namely the Maximum Likelihood Estimation (MLE) has been used for this purpose. Maximum likelihood estimation begins with writing a mathematical expression known as the Likelihood Function of the history data. Loosely speaking, the likelihood of a set of data is the probability of obtaining that particular set of data, given the chosen probability distribution model. This expression contains the unknown model parameters. The values of these parameters that maximize the sample likelihood are known as the replacing existing building energy systems.

For example, considering the SARIMA model of (9), since the random noise sequence {aₜ} is normally distributed with zero mean, its probability density function for (a₁,a₂, . . . aₙ) can be written as

$$p ( {a}_{1} , {a}_{2} , … {a}_{n} ) = \frac{1}{{( 2 π )}^{N / 2} {σ}^{N}} exp ( - {\sum }_{j = 1}^{N} {a}_{j}^{2} / 2 {σ}^{2} ) \qquad ( 11 )$$

where N is the number of measurements. The logarithm of the probability density function then becomes

$$L = - \frac{1}{2 {σ}^{2}} {\sum }_{j = 1}^{N} {a}_{j}^{2} - N log σ + const$$

Now let p({yₜ}, β) be the probability density function of the measurement (energy consumption data) given the parameter set β=[φ,φ′,θ,θ′]^{T}. The likelihood function is defined as the function p(.,.) regarded as a function of parameters θ and with the observed values {yₜ} inserted. The maximum likelihood for β is that value that maximizes the likelihood function. It's clear from equation (11) that the likelihood function can be maximized by minimizing the sum of squares

$$S ( β ) = {\sum }_{j = 1}^{N} {a}_{j}^{2} .$$

Expanding aₜ in a Taylor series about its value corresponding to some guessed set of parameter values β=[φ,φ′,θ,θ′]^{T}, we have approximately

$$\begin{matrix}{a}_{t} = {a}_{t}^{0} - {\sum }_{i = 1}^{k} ( {β}_{i} - {β}_{i}^{0} ) {v}_{i , t} , 1 , \\ where k = p + q + P + Q and {v}_{i , t} = - \frac{\partial {a}_{t}}{\partial {β}_{t}} \vert β = {β}^{0} \\ and 1 < t < N , 1 < i < k .\end{matrix} \qquad ( 12 )$$

Now if V is the matrix with elements v_{i,t}, then (12) can be written in matrix form

\overline{a}⁰=V(β−β⁰)+\overline{a}

where \overline{a}⁰ and \overline{a} are column vcectors of a time series of at values. The adjustments β−β⁰ that minimize S(β)=\overline{a}^{T} \overline{a} can now be obtained by linear least squares

β−β⁰={V^{T}V}⁻¹V^{T}\overline{a}⁰

or

β=β⁰={V^{T}V}⁻¹V^{T}\overline{a}⁰ (13)

Since (13) is only an approximation, the least square values will not be obtained in a single adjustment. Therefore the last parameter estimates are substituted as new guesses (β⁰) and the process is repeated until convergence occurs. The better the initial guess about parameter set β⁰ faster will be the convergence. Though zero initial values yield the final estimate of the parameter set, sometime it may lead non-convergence of MLE iteration. To avoid this problem, usually the autocorrelation structure of observed data is used to obtain the initial guess of parameters.

For the reference building taken in the previous section, the convergence curve of MLE done for parameter set β=[φ,φ′,θ,θ′]^{T} with two decimal point accuracy is shown at 800 in FIG. 8.

It is inferred from this plot that parameter set β=[φ,φ′,θ,θ′]^{T} show no variation beyond the 35^{th} iteration.

Model Diagnostic Checking:

The model having been identified and the parameters estimated, the adequacy of the model has to be checked. In practice, the autocorrelation function of the residuals and/or the cumulative periodogram of the residuals are used to perform this diagnostic checking. In our application, the ACF test on the residual has been applied to check whether the model is adequate. During the iterative parameter estimation, if there is any serious model inadequacy found from the diagnostic check, the model needs to be modified before the next iterative cycle.

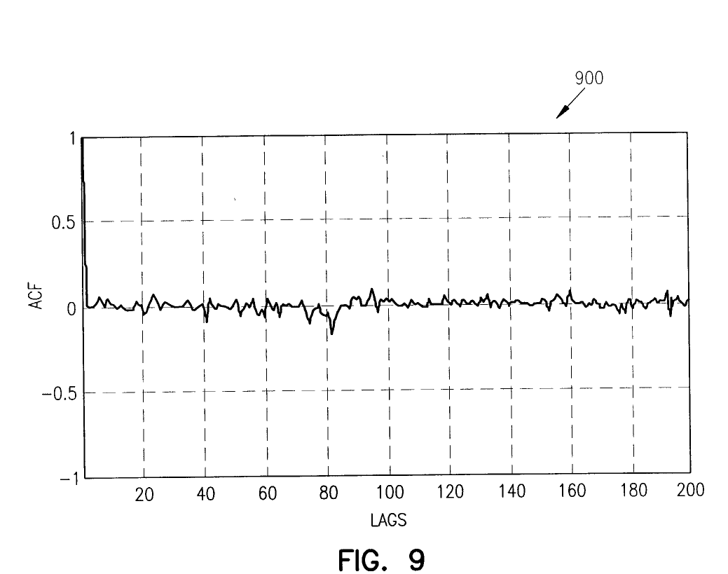

Ideally, the condition for a model to be adequate is that the autocorrelation function estimate of the residual at must be an independent zero mean random noise sequence (ACF is zero for all nonzero lags). The residual ACF based model diagnostic check basically ensures this criteria for its adequacy. Hence in case the ACF of the residual is not a random noise sequence, additional parameters are added to the model. The ACF plot of the residual shown at 900 in FIG. 9 during MLE routine closely matches that of the random sequence. So it can be concluded that the fitted model is adequate and no further change is needed.

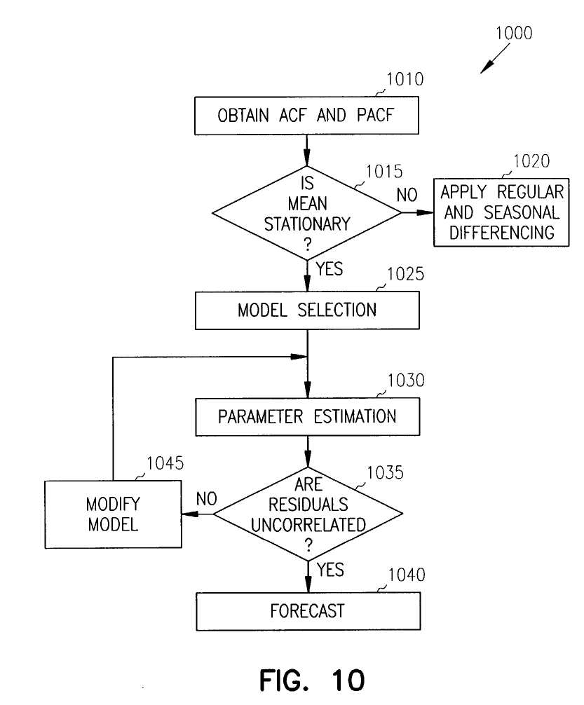

The complete task of data modeling is comprised of three subtasks of model identification (data differencing and model order identification), model parameter estimation and model diagnostic checking. The flow chart at 1000 in FIG. 10 depicts these steps. At 1010, the ACF and PACF are obtained. The mean is then checked at 1015 to ensure that it is stationary. If not, at 1020, regular and seasonal differencing is applied. If the means is stationary, model selection is performed at 1025. Parameter estimation occurs at 1030 to determine parameters for the selected model. At 1035, a check is made to determine whether residuals are uncorrelated. If they are, a forecast is done at 1040. If not, the model is modified at 1045, and processing returns to parameter estimation block 1030.

Forecasting:

The ultimate aim of forecasting energy consumption is a straightforward procedure once the model building task is completed successful. Given history data up to say time instant ‘t’ and the desire to forecast up to lead time ‘1’ (i.e.) yₜ₊₁, 1≧1, there are three ways by which this could be accomplished. One direct approach is to express the model in difference equation form and extend the same for future time instants. For example, for our SARIMA (1,1,1)*(1,1,1) model, forecast values can be obtained as

(1−φB)(1−φ′B⁶⁷²)zₜ₊₁=(1−θB)(1−θ′B⁶⁷²)aₜ₊₁,

or

zₜ₊ₗ=φ₁zₜ₊ₗ₋₁+φ′₁zₜ₊ₗ₋₁−φ₁φ′₁zₜ₊ₗ₋₂+aₜ₊ₗ−θ₁aₜ₊ₗ₋₁θ′₁a ₜ₊ₗ₋₁+θ₁θ′₁aₜ₊ₗ₋₂

where zₜ₊ₗ=∇¹∇₆₇₂¹yₜ is the data after regular and seasonal differencing

Taking conditional expectation at time t we get,

[zₜ₊ₗ]=\hat{z}ₜ(l)=φ₁[zₜ₊ₗ₋₁]+φ′₁[z_{t+l-1]-φ}₁φ′₁[zₜ₊₁₋₂]+[aₜ₊ₗ]−θ₁[aₜ₊ₗ₋₁]−θ′₁[aₜ₊ₗ₋₁]+θ₁θ′₁[aₜ₊ₗ₋₂]

The conditional expectations [z_{t+l] and [a}ₜ₊ₗ] of z and a respectively can be defined using the following rules

[zₜ₋ⱼ]=E[zj=z,j j=0,1,2 . . .

[z,+j=E[z,+j]=Zf (1) j=1,2,3 . . .

[a,]=,E[a,,]=a,t, =zt j- ZtiI (1) j=0,1,2 . . .

[a,+,]=E[a,+j]=0 j=1,2,3 . . .

For illustration, let's express forecast values for first two lead times

\hat{z}ₜ(1)=φ₁[zₜ]+φ′₁[zₜ]−φ₁φ′₁[zₜ₋₁]+[aₜ₊₁]−θ₁[aₜ]−θ′₁[aₜ]+θ₁θ′₁[aₜ₋₁]

\hat{z}ₜ(2)=φhd 1[zₜ₊₁]+φ′₁[zₜ₊₁]−φ₁φ′₁[zₜ]+[aₜ₊₂]−θ₁[aₜ₊₁]−θ′₁[aₜ₋₁]+θ₁θ′₁[aₜ]

Applying the conditional expectation definitions, we get

\hat{z}ₜ(1)=φ₁zₜ+φ′₁zₜ−φ₁φ′₁zₜ₋₁−θ₁(zₜ−zₜ₋₁)−θ′₁(zₜ−\hat{z}ₜ₋₁(1))+θ₁θ′₁(zₜ₋₁−\hat{z}ₜ₋₂(1))

\hat{z}ₜ(2)=φ₁\hat{z}ₜ(1)+φ′₁\hat{z}ₜ(1)−φ₁φ′₁zₜ+θ₁θ′₁(zₜ−\hat{z}ₜ₋₁(1))

It can be easily seen that the forecasts are readily generated recursively in the order \hat{z}ₜ(1), \hat{z}ₜ(2), . . . . Though it's possible to obtain forecast for any lead time with this method, compromise on accuracy of the forecasting has to be made if the lead time goes beyond certain value. This is because the model built for the history data may deviate from the actual system dynamics. For this, it is practice to update the model at regular intervals. In our application, the forecasting is done for the next one week's time at 15 min interval and model update is done as and when the observation (actual) data from the energy meter arrives.

Kalman Filter:

A Kalman filter is used for estimation and prediction of the SARIMA model. Kalman filtering is an optimal state estimation technique, which has the ability to incorporate noise from both measurement and modeling. Owing to its more accessible, faster and cheaper means of computation, Kalman filter has find plenty of application in recent years. The discrete Kalman filter is a recursive predictive update technique used to determine the correct states of a process model. Given some initial estimates, it allows the states of a model to be predicted and adjusted with each new measurement, providing an estimate of error at each update. It has been proven that, in the right situation, when certain assumptions about the noise model are satisfied.

A feature of Kalman filter, not present in other statistical predictors, is its ability to adjust its own parameters automatically according to the statistics of the measurements, and according to the current confidence in the accuracy of the state parameters.

Description of Kalman Filter

The state space model of Kalman filter is associated with two equations viz., process equation and measurement equation. The process equation is expressed as

x(n+1)=A*x(n)+B*v(n+1) (14)

where x(n) is the state vector of the system at time instant t=n and v(n) is the process noise sequence.

The only information available about this system is its sequence of observations and is related to the state vector by the measurement equation

y(n+1)=C*x(n+1)+D*w(n+1) (15)

where y(n) is the observation vector and w(n) is the measurement noise sequence. The requirement on noise sequences is that they must be uncorrelated with zero mean.

$$\begin{matrix}E [ v ( m ) \cdot v ( n ) ] = \{ \begin{matrix}Q ( m ) & m = n \\ 0 & m \neq n\end{matrix} \\ E [ v ( m ) \cdot v ( n ) ] = \{ \begin{matrix}R ( m ) & m = n \\ 0 & m \neq n \\ 1 & \end{matrix}\end{matrix}$$

where Q and R are process noise covariance and measurement noise covariance respectively. The symbols A,B,C and D are the system parameters in state space form.

Given these two system equations, the Kalman filtering consists of two steps; the time update, which takes into account the error in modeling the system dynamics and the measurement update, which takes into account the effect of error in the measurement of the system output.

Time Update

Given a sample x(n) at time instant ‘n’, the time update step predicts \hat{x}⁻ (n+1), the state estimate for the next instant using process equation (14). Here the hat denotes estimate and super minus indicate that this is the best estimate of the state vector x before actual measurement y(n+1) arrive. The error associated with this prediction is estimated via prediction error covariance, a measure of uncertainty in the prediction. It is the sum of two terms; the first due to system dynamics and the other is an increase in uncertainty due to the process noise v(n).

P⁻(n+1)=AP(n)A^{T}+BQ(n+1)B^{T}

Measurement Update

It basically performs the correction on the predicted value with the help of observation y(n+1) to obtain updated estimate \hat{x}(n+1). For this, it computes Kalman gain, which is the proportion of the error between predicted and measurement parameters and be expressed as

K(n+1)=P⁻(n+1)C^{T}[CP⁻(n+1)C^{T}+R(n+1)]⁻¹

Now the measurement update estimate is calculated by the equation

x(n+1)=x⁻(n+1)+Ky(n+1)−KCx⁻(n+1)

Similar to state estimate update, the error covariance is also updated using Kalman gain as follows

P(n+1)=[I−KC]P⁻(n+1)

where I is the identity matrix.

The error between the estimated and measured parameters can be considered to be a prediction error for the Kalman filter and is caused by the inaccurate measurement, an inaccurate prediction, or a combination of these. A portion of the prediction error is added to the parameter estimate \hat{x}⁻(n+1) to produce an updated state parameter vector x(n+1). The proportion is decided by the values held in the gain matrix K.

Kalman Filter for Energy Forecasting:

Among various special features of Kalman filter discussed, the efficient state space based model estimation and optimal estimation even under the noisy data condition are the two major factors prompted its usage in SARIMA model based energy forecasting. Though both difference equation based forecasting and Kalman filter prediction are iterative procedure, the efficient computational capability of Kalman filter has edge over the former.

The application of Kalman filter for SARIMA model is straightforward with state matrix A comprises of AR parameters of regular and seasonal models and MA parameters forming the matrix B. Assuming there are no measurement error in the energy meters, the system matrices C and D of the measurement equation are

C=Identity matrix, D=0;

Hence (14) and (15) can be written as

x(n+1)=[φₚ; φ′_{P}]x(n)+[θ_{q}; θ′_{Q}]v(n+1) (16)

where x(n) is the energy consumption at time instant t=n and v(n) is the random noise sequence.

y(n+1)=Ix(n+1) (17)

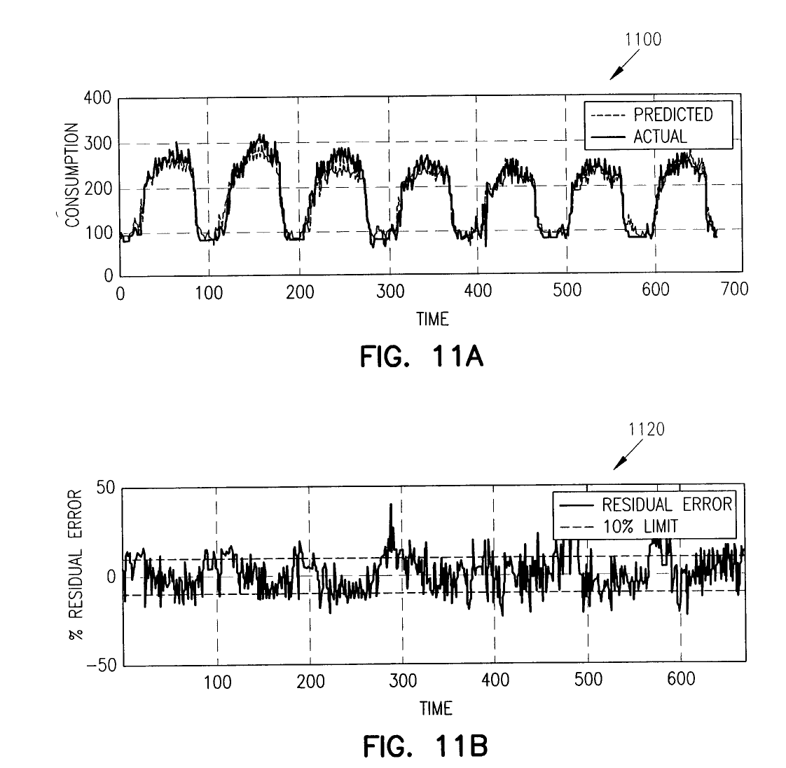

The forecasting result using Kalman filter based SARIMA model for a reference building is shown in FIG. 11 with predicted and actual forecasting results indicated at 1110 and a residual error with superimposed 10% limits are shown at 1120.

In one embodiment, the SARIMA model based forecasting method learns from the history data, the seasonal and non-seasonal behavior of load curve, and projects the same for the future time indices as forecast values. It works well as long as the independent (extraneous) variable remains the same during a modeling and forecasting period. Otherwise, its impact may deviate the forecast values from the actual consumption. One such extraneous factor, which may drastically affect the energy consumption, is the weather condition (temperature, humidity etc). For example the peak energy consumption in a day is a direct function of peak outside air temperature. When the peak temperature rises, more cooling effort has to be carried out so as to maintain the comfort level of the building occupants. Similarly during winter, more power may have to be spent on heating equipment to bring the temperature up towards the human comfort level.

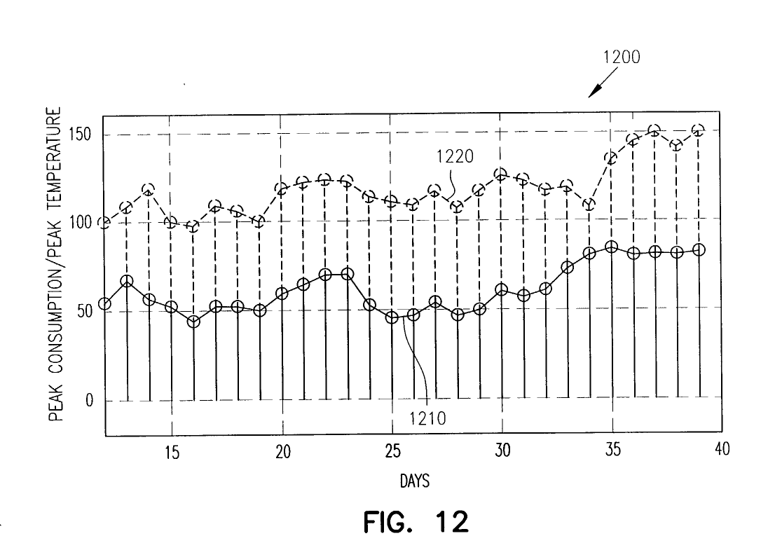

FIG. 12 at 1200 depicts the day-to-day variation of peak energy consumption 1210 against peak temperature 1220. Consumption and temperature have been found to have a peak cross correlation coefficient of 0.6 in one study. Hence one or more independent variable(s) have to be incorporated to the SARIMA model in order to make it more dynamic. The next section deals with extension of the SARIMA model for this purpose.

The effect of temperature is seen more during the peak business hours (i.e.) when the building is 100% occupied. A temperature factor is incorporated during peak business hours rather than throughout the day in one embodiment. For the rest of the day, the forecasting is made purely based on SARIMA model. In one embodiment, the energy forecasting for the entire day (using SARIMA) and peak energy forecasting (using correlation analysis) are made separately. Later the temperature effect on peak business hours consumption is added to SARIMA results through an incremental factor. This factor is computed as the difference between peak load forecast and peak load in the previous day (or week) peak load. The incremental factor is positive if temperature of the forecast day has increased from previous day (or week) and negative otherwise.

For example, given 2 months of history data (consumption and temperature) and the desire to forecast consumption for the next one week's time. The algorithm runs in the following manner:

(i) Given the temperature forecast, the correlation analysis yields the peak load forecasting for next one week.

(ii) The SARIMA model produces forecasts for next one-week at all points without considering temperature.

(iii) Obtain the incremental factor, which is difference between peak forecast and actual peak load corresponding to the last week of the history data.

(iv) Modify the peak business hours forecasts obtained from SARIMA model by adding it to the incremental factor.

In the past, considerable effort has been put on to reflect the temperature effect on SARIMA model forecasting. Developing multiple SARIMA models for different climatic seasons is relatively simple method among them. However it requires huge amounts of history data belonging to all seasons for model building. Similarly the cause and effect approach, comprising a transfer function polynomial (relating consumption and temperature) and a residual model (usually a SARIMA model) is another alternative candidate. However the model identification and estimation of transfer function polynomial is highly tedious and time consuming.

### CONCLUSION

The combined Kalman filter-SARIMA model technique of forecasting has been tested on the consumption data of many commercial buildings. Some of the advantages of different embodiments of this method might include:

(i) Efficient parameter estimation for SARIMA model

(ii) Accuracy of up to 90% and above

(iii) Minimal configuration complexity in applying this algorithm for multiple buildings.

(iv) Less modeling and forecasting effort

(v) Need minimal amount (about only two months) of history data for modeling.

(vi) Sensitive to weather changes.

1. A computer implemented energy consumption forecasting method comprising:
identifying a model underlying energy consumption data;
estimating parameters for the model using a recursive predict—update technique; and
generating a forecast with the model using the estimated parameters.

2. The method of claim 1 wherein the recursive predict—update technique comprises a Kalman filter.

3. The method of claim 2 wherein the Kalman filter has the ability to adjust its own parameters automatically according to statistics of measurements, and according to a current confidence in the accuracy of the state parameters.

4. The method of claim 2 wherein Kalman filtering comprises:
updating time by taking into account the error in modeling the system dynamics; and
updating measurement of system output by taking into account the effect of error in the measurement of the system output.

5. The method of claim 4 wherein a process equation is expressed as
x(n+1)=A*x(n)+B*v(n+1),
where x(n) is the state vector of the system at time instant t=n and v(n) is the process noise sequence and A and B are system parameters in state space form.

6. The method of claim 4 wherein a measurement equation is expressed as
y(n+1)=C*x(n+1)+D*w(n+1)
where y(n) is the observation vector and w(n) is the measurement noise sequence and C and D are system parameters in state space form.

7. The method of claim 1 and further comprising performing diagnostics on the model.

8. The method of claim 1 wherein identifying the model comprises converting modeling data to stationary data.

9. The method of claim 1 and further comprising converting modeling data to stationary data by differencing both regular and seasonal data with past samples to determine the model.

10. A computer readable medium having instructions for causing a computer to perform a method of energy consumption forecasting, the method comprising:
identifying a model underlying energy consumption data;
estimating parameters for the model using a recursive predict—update technique; and
generating a forecast with the model using the estimated parameters.

11. The computer readable medium of claim 1 wherein the recursive predict—update technique comprises a Kalman filter.

12. The computer readable medium of claim 11 wherein the Kalman filter has the ability to adjust its own parameters automatically according to statistics of measurements, and according to a current confidence in the accuracy of the state parameters.

13. The computer readable medium of claim 11 wherein Kalman filtering comprises:
updating time by taking into account the error in modeling the system dynamics; and
updating measurement of system output by taking into account the effect of error in the measurement of the system output.

14. A computer implemented energy consumption forecasting method comprising:
identifying a Seasonal AutoRegressive Integrated Moving Average SARIMA (p,d,q)* (P,D,Q) model where d and D denote non-seasonal and seasonal order of a data differencing model for forecasting energy consumption, p and P denote non-seasonal and seasonal previous values and q and Q denote non-seasonal and seasonal previous shocks;
estimating parameters for the model using a Kalman filter; and
generating a forecast with the model using the estimated parameters.

15. The method of claim 14 wherein the Kalman filter has the ability to adjust its own parameters automatically according to statistics of measurements, and according to a current confidence in the accuracy of the state parameters.

16. The method of claim 14 wherein Kalman filtering comprises:
updating time by taking into account the error in modeling the system dynamics; and
updating measurement of system output by taking into account the effect of error in the measurement of the system output.

17. A computer readable medium having instructions for causing a computer to perform a method of energy consumption forecasting, the method comprising:
identifying a Seasonal AutoRegressive Integrated Moving Average SARIMA (p,d,q)* (P,D,Q) model where d and D denote non-seasonal and seasonal order of a data differencing model for forecasting energy consumption, p and P denote non-seasonal and seasonal previous values and q and Q denote non-seasonal and seasonal previous shocks;
estimating parameters for the model using a Kalman filter; and
generating a forecast with the model using the estimated parameters.

18. A system for energy consumption forecasting, the system comprising:
a module that identifies a Seasonal AutoRegressive Integrated Moving Average SARIMA (p,d,q)* (P,D,Q) model where d and D denote non-seasonal and seasonal order of a data differencing model for forecasting energy consumption, p and P denote non-seasonal and seasonal previous values and q and Q denote non-seasonal and seasonal previous shocks;
a module that estimates parameters for the model using a Kalman filter; and
a module that generates a forecast with the model using the estimated parameters.

19. A system for forecasting energy consumption, the system comprising:
means for identifying a model underlying energy consumption data;
means for estimating parameters for the model using a recursive predict—update technique; and
means for generating a forecast with the model using the estimated parameters.

20. The system of claim 19 wherein the recursive predict—update technique comprises a Kalman filter.

21. The system of claim 20 wherein the Kalman filter has the ability to adjust its own parameters automatically according to statistics of measurements, and according to a current confidence in the accuracy of the state parameters.

22. The system of claim 20 wherein Kalman filtering comprises:
updating time by taking into account the error in modeling the system dynamics; and
updating measurement of system output by taking into account the effect of error in the measurement of the system output.

23. The system of claim 22 wherein a process equation is expressed as
x(n+1)=A*x(n)+B* v(n+1),
where x(n) is the state vector of the system at time instant t=n and v(n) is the process noise sequence and A and B are system parameters in state space form.

24. The system of claim 22 wherein a measurement equation is expressed as
y(n+1)=C*x(n+1)+D*w(n+1)
where y(n) is the observation vector and w(n) is the measurement noise sequence and C and D are system parameters in state space form.

25. The system of claim 19 and further comprising performing diagnostics on the model.

26. The system of claim 19 wherein identifying the model comprises converting modeling data to stationary data.

27. The system of claim 26 wherein converting modeling data to stationary data comprises differencing the data with past samples.

28. The system of claim 19 and further comprising:
means for adding an incremental factor to the energy forecast based on temperature.

29. The system of claim 28 wherein the incremental factor is positive if a temperature of a forecast day is higher than the temperature for a period prior to the forecast day.

30. The system of claim 29 wherein the incremental factor is the difference between a peak forecast and actual peak load corresponding to the prior period.

31. A computer implemented energy consumption forecasting method for a plurality of commercial buildings, the method comprising:
receiving an indication of a building for which to provide a forecast;
identifying a model for forecasting energy consumption for the building;
estimating parameters for the model using a recursive predictive update technique; and
generating a forecast with the model using the estimated parameters.

32. The method of claim 31 wherein the forecast for the building is provided approximately every 15 minutes.

33. The method of claim 31 and further comprising:
including a temperature effect in the model.

34. A computer implemented energy consumption forecasting method comprising:
identifying a model underlying energy consumption data;
estimating parameters for the model using a recursive predict—update technique;
generating a forecast with the model using the estimated parameters; and
adding a temperature effect to a peak energy consumption of the forecast.

35. The method of claim 34, wherein the temperature effect is computed as a difference between peak load forecast and peak load in a previous period.

36. The method of claim 35 wherein the period is a day or a week.

37. The method of claim 35 wherein the temperature effect is positive if the temperature of the forecast day has increased from the previous period.
